(19) United States
(12) Patent Application Publication
(10) Pub. No.: US 2026/0187726 A1
(43) Pub. Date: Jul. 2, 2026

(54) HARDWARE-ANCHORED LIQUIDITY CONTAINMENT AND CAPITAL RESERVE ENFORCEMENT ENGINE WITH ATTESTATION-BOUND REAL-TIME SETTLEMENT CONTROLS

(71) Applicant: George William Bickerstaff, III, Greenwich, CT (US)

(72) Inventor: George William Bickerstaff, III, Greenwich, CT (US)

(21) Appl. No.: 19/547,244

(22) Filed: Feb. 23, 2026

(51) Int. Cl. G06Q 40/04; G06F 21/53; H04L 9/00; H04L 9/32

(52) U.S. Cl. CPC G06Q 40/043; G06F 21/53; H04L 9/3221; H04L 9/50

(57) ABSTRACT

A hardware-anchored Liquidity Containment and Capital Reserve Enforcement Engine executes real-time reserve validation, liquidity sufficiency computation, and deterministic settlement gating entirely within trusted execution environments (TEEs) comprising Intel SGX enclaves, AMD SEV-SNP protected VMs, or ARM TrustZone secure worlds, materially altering processor states to isolate all reserve computation. Liquidity Integrity Vectors are computed using the reserve adequacy function h(alpha, beta, gamma) from hardware-attested inputs anchored to TEE-resident hardware mechanisms comprising enclave-sealed monitoring registers, memory encryption engine integrity states, or attestation-based recalibration triggers. A Liquidity Containment Gate enforces a non-bypassable hardware execution barrier requiring all LIV computation, Capital Reserve Monitor validation, and ZKP proof generation to complete within a single attested TEE execution instance before settlement authorization is released. A ZKP Verification Engine generates Groth16 arithmetic-circuit proofs of approximately 192 bytes verifiable in under 10 milliseconds, enabling External Counterparty verification of reserve sufficiency without disclosure of proprietary balance sheet data. A Provenance Ledger stores append-only cryptographic hash chains with each entry bound to a TEE attestation report. A Settlement Attestation Binder cryptographically binds settlement authorizations to specific TEE attestation report identifiers, enabling independent verification of both settlement outcomes and the hardware environments that authorized them.

### FIELD OF THE INVENTION

This invention relates to hardware-secured artificial intelligence systems for real-time capital reserve monitoring, liquidity containment, and settlement authorization in financial infrastructure, specifically to a Liquidity Containment and Capital Reserve Enforcement Engine that executes reserve validation, liquidity sufficiency modeling, and deterministic settlement gating entirely within a Trusted Execution Environment (TEE) comprising an Intel SGX enclave, AMD SEV-SNP protected virtual machine, or ARM TrustZone secure world that materially alters the processor state by invoking secure enclave isolation to enforce capital adequacy and liquidity thresholds as hardware-level pre-conditions to settlement finality. This application cross-references U.S. patent application Ser. No. 17/987654, the entire contents of which are incorporated herein by reference for hardware-attested workflow enforcement mechanisms.

### BACKGROUND OF THE INVENTION

Modern capital markets operate on settlement infrastructure that assumes liquidity sufficiency and capital reserve compliance at periodic checkpoints rather than enforcing those conditions continuously at the moment of each transaction. Regulatory frameworks governing financial institutions—including Basel III capital adequacy requirements, Liquidity Coverage Ratio (LCR) standards, and Net Stable Funding Ratio (NSFR) rules—were designed around reporting intervals, supervisory audits, and post-hoc reconciliation cycles. The temporal gap between when capital reserve conditions are validated and when settlement actually occurs is a structural vulnerability: a transaction can be authorized and committed while the institution's reserve position has already deteriorated below regulatory thresholds, with the shortfall not detected until the next reconciliation window. This architecture makes capital compliance a reporting function rather than an execution constraint, and the consequences of that design choice—including systemic liquidity crises, contagion events, and regulatory enforcement actions—are documented in the history of financial market disruptions.

AI-driven trading platforms and automated underwriting systems have dramatically accelerated transaction velocity beyond the cadence that traditional compliance review can match. Algorithmic trading systems can execute thousands of transactions per second, each of which may individually appear compliant but whose aggregate effect on the institution's liquidity position may create a reserve shortfall that no periodic compliance checkpoint would catch in time. Liquidity depletion events can cascade across interconnected counterparties before regulators or clearing houses detect reserve shortfalls at any single institution. The fundamental problem is not that institutions lack compliance frameworks—they have extensive ones—but that those frameworks operate on a time scale mismatched to the transaction velocity of modern automated financial systems.

Software-based liquidity monitoring systems attempt to close this gap by running continuous monitoring dashboards and automated alerting. However, these systems share a structural deficiency: they operate within the same software stack as the AI-driven trading and underwriting systems they are supposed to monitor. A monitoring system that can be configured, updated, or overridden by the same administrative users who operate the trading system provides no hardware-level guarantee that alerts will be generated when reserve conditions are breached. Configuration drift—the gradual, often unintentional divergence of a monitoring system's thresholds from intended values—can silently disable the alerting function without generating any record that the change occurred. Because software-based monitoring systems operate outside hardware-isolated environments, their outputs are not non-repudiable: a regulator or counterparty examining the compliance record cannot cryptographically verify that the reserve validation was performed by an unmodified system in the correct state.

Blockchain-based settlement layers address the immutability problem—once a transaction is recorded, it cannot be altered—but they do not address the pre-settlement enforcement problem. A blockchain records what was authorized; it does not prevent authorization when reserve conditions are insufficient. Settlement can be committed to an immutable blockchain record while the authorizing institution's liquidity position is below regulatory thresholds, producing an immutable record of a non-compliant settlement event. There remains a fundamental need for a system that enforces capital reserve adequacy and liquidity sufficiency as hardware-level pre-conditions to settlement finality—where settlement cannot be committed unless a tamper-proof hardware execution environment has verified that all reserve conditions are satisfied, and where the verification record is cryptographically bound to the specific hardware environment that performed it.

### SUMMARY OF THE INVENTION

This invention is a Liquidity Containment and Capital Reserve Enforcement Engine—a system that moves capital adequacy enforcement from the audit cycle into the hardware of the settlement system itself, making every settlement authorization physically contingent on hardware-verified reserve sufficiency. Think of it as a circuit breaker built directly into the financial system's processor: no settlement can be committed until tamper-proof hardware has verified that the institution's liquidity buffers and capital reserve ratios satisfy all applicable thresholds, and every verification event generates a cryptographic proof that regulators and counterparties can independently confirm in under 10 milliseconds without accessing the institution's proprietary balance sheet data.

The core technical problem solved by this invention is the temporal enforcement gap between capital reserve validation and transaction settlement. Existing systems validate reserve adequacy at reporting intervals; this invention validates it at execution time, inside hardware that cannot be overridden by the software stack. The primary mechanism is a Liquidity Integrity Engine that continuously computes a Liquidity Integrity Vector (LIV)—a multidimensional hardware-attested reserve adequacy metric—using the reserve adequacy function h(alpha, beta, gamma) where alpha represents liquid asset buffers derived from TEE-resident hardware-attested financial data inputs, beta represents real-time exposure metrics from the current transaction pipeline state inside the TEE, and gamma represents regulatory capital multipliers retrieved from the TEE-sealed policy store. The LIV is evaluated by the Liquidity Containment Gate, a non-bypassable hardware-enforced execution barrier that blocks settlement finality unless the LIV satisfies all authorization conditions within a single attested TEE Execution Instance prior to enclave termination.

The primary technical mechanisms are three integrated hardware-enforced components operating within the TEE. First, the Capital Reserve Monitor anchors all reserve ratio calculations to TEE-resident hardware mechanisms—specifically, enclave-sealed monitoring registers, memory encryption engine integrity states, and attestation-based recalibration triggers—so that reserve monitoring signals cannot be falsified by software outside the TEE and input quality drift triggers a hardware-level suspension alert. Second, the ZKP Verification Engine generates Groth16 arithmetic-circuit proofs inside the TEE that allow regulators and External Counterparties to verify reserve sufficiency without accessing the institution's proprietary balance sheet data. Third, the Settlement Attestation Binder cryptographically binds every settlement confirmation to the TEE attestation report of the specific TEE Execution Instance that authorized it, creating a non-repudiable linkage between the settlement outcome and the hardware environment that verified the reserve conditions.

The system additionally includes a Liquidity Stress Modeler (also referred to herein as the Optimization and Simulation Engine, as labeled in FIG. 4) that stress-tests liquidity scenarios and reserve adequacy projections inside the TEE, and an append-only Provenance Ledger that cryptographically records every reserve validation event, Liquidity Containment Gate decision, and settlement authorization with hash-chain binding to TEE attestation reports. Together, these components create a closed loop: balance sheet data enters the TEE, the LIV is computed, the Liquidity Containment Gate evaluates reserve sufficiency, a ZKP proof is generated, settlement is authorized or blocked, and every outcome is permanently recorded in the Provenance Ledger—all within the hardware isolation boundary, with the Settlement Attestation Binder applying attestation-bound finality to every authorized transaction.

The invention provides a measurable technological improvement over existing systems by: (a) materially altering the computer processor's execution state by invoking hardware-isolated TEE enclaves to isolate and transform sensitive liquidity computation data; (b) anchoring reserve monitoring to physical hardware registers inside the TEE so that the institution's liquidity position accuracy cannot silently degrade without triggering a hardware alert; and (c) combining hardware-enforced pre-settlement reserve validation, privacy-preserving ZKP verification, and attestation-bound settlement finality into a single integrated architecture that no prior system achieves. This combination satisfies 35 U.S.C. Section 101 as a concrete technical improvement to computer security and financial data processing, and demonstrates non-obviousness under 35 U.S.C. Section 103 because the combination produces results—specifically, deterministic pre-settlement capital adequacy enforcement with independently verifiable compliance proofs at transaction velocity—that no predictable combination of blockchain-only ledgers, software-only monitoring systems, or periodic regulatory audit processes achieves. The claimed architecture reduces computational redundancy in capital compliance workflows by replacing periodic reconciliation audits with constant-size cryptographic verification operations executed in hardware-isolated environments.

### BRIEF DESCRIPTION OF THE DRAWINGS

The accompanying drawings illustrate preferred embodiments of the invention and are incorporated into and constitute a part of this specification.

FIG. 1 illustrates the overall system architecture, including subfigures:

FIG. 1A—Liquidity Integrity Engine;

FIG. 1B—Capital Reserve Monitor;

FIG. 1C—Liquidity Containment Gate;

FIG. 1D—ZKP Verification Engine;

FIG. 1E—Provenance Ledger.

FIG. 2 depicts the primary processing pipeline, including subfigures:

FIG. 2A—Input Ingestion Gate;

FIG. 2B—LIV Computation Module;

FIG. 2C—Reserve Threshold Evaluator;

FIG. 2D—Containment Decision Engine;

FIG. 2E—Settlement Authorization Gate.

FIG. 3 shows the security and verification flow, including subfigures:

FIG. 3A—TEE Isolation Layer;

FIG. 3B—Enclave-Sealed Register Interface;

FIG. 3C—Memory Encryption Engine;

FIG. 3D—Attestation Report Generator;

FIG. 3E—Hash Chain Binder.

FIG. 4 illustrates the Liquidity Stress Modeler (also referred to herein as the Optimization and Simulation Engine), including subfigures:

FIG. 4A—Liquidity Stress Modeler;

FIG. 4B—Scenario Stress Tester;

FIG. 4C—LIV Calibration Loop;

FIG. 4D—Reserve Projection Engine;

FIG. 4E—Coefficient Recalibrator.

FIG. 5 depicts the interoperability and settlement layer, including subfigures:

FIG. 5A—Settlement Attestation Binder;

FIG. 5B—Cross-Institution Verifier;

FIG. 5C—Multi-Party ZKP Coordinator;

FIG. 5D—Rollback Controller;

FIG. 5E—Final Commit Seal.

### DETAILED DESCRIPTION OF THE INVENTION

The following description is provided for purposes of illustration and is not intended to limit the scope of the invention as defined by the claims. Embodiments may be implemented in hardware, software, or a combination thereof.

### Definitions

The following terms are used consistently throughout this specification:

Capital Reserve Monitor: A TEE-resident hardware-anchored monitoring component that continuously validates the integrity and sufficiency of an institution's capital reserve position by reading hardware-derived integrity signals from TEE-resident hardware mechanisms—specifically, enclave-sealed monitoring registers, memory encryption engine integrity states, and attestation-based recalibration triggers. The Capital Reserve Monitor computes reserve ratio metrics from hardware-attested balance sheet inputs and compares them against regulatory thresholds stored in the TEE-sealed policy store. When reserve ratio calculations reveal a shortfall or when the integrity signals from the enclave-sealed monitoring registers indicate that input data quality has drifted beyond a configurable tolerance threshold since the last hardware-attested calibration cycle, the Capital Reserve Monitor triggers a hardware-level liquidity suspension alert and suspends Liquidity Containment Gate authorization pending hardware-attested recalibration and generation of a new TEE attestation report. This component executes within a TEE for non-repudiable, hardware-verified reserve adequacy monitoring.

External Counterparty: Any entity outside the TEE isolation boundary that participates in settlement or capital markets transactions governed by this system, including without limitation clearing houses, central counterparties, central banks, correspondent financial institutions, and regulatory verification systems. An External Counterparty interacts with the system exclusively through cryptographically verified ZKP proof exchanges and TEE attestation reports, and never receives underlying proprietary balance sheet data or reserve position information in any transaction.

Liquidity Containment Gate: A TEE-resident non-bypassable hardware execution barrier that enforces deterministic reserve adequacy conditions as a pre-condition to settlement finality. The Liquidity Containment Gate evaluates the Liquidity Integrity Vector against policy thresholds retrieved from the TEE-sealed policy store and permits settlement authorization only when all of the following conditions are satisfied within a single TEE Execution Instance prior to enclave termination: (i) the Liquidity Integrity Vector satisfies the applicable LCR and capital reserve thresholds; (ii) the Capital Reserve Monitor confirms that reserve ratios fall within the authorized range; (iii) the Capital Reserve Monitor's hardware integrity signals confirm input data has not drifted beyond the configured tolerance threshold; and (iv) the ZKP Verification Engine has generated a valid proof of reserve sufficiency. This gate executes within a TEE to ensure that settlement authorization cannot be granted by software-level override or administrative action outside the hardware isolation boundary.

Liquidity Integrity Engine: A TEE-resident AI computation module that generates the Liquidity Integrity Vector from hardware-attested balance sheet inputs using the reserve adequacy function h(alpha, beta, gamma), where alpha represents liquid asset buffers derived from TEE-resident hardware-attested financial data inputs, beta represents real-time exposure metrics derived from the current transaction pipeline state inside the TEE, and gamma represents regulatory capital multipliers retrieved from the TEE-sealed policy store, such that the output of h constitutes the Liquidity Integrity Vector for the institution at the time of the TEE Execution Instance in which the computation was performed. The Liquidity Integrity Engine's model configuration is sealed inside the TEE at initialization, cryptographically bound to the TEE attestation report, and cannot be silently modified between computation events. This engine executes within a TEE for hardware-anchored, non-repudiable reserve adequacy computation.

Liquidity Integrity Vector (LIV): A hardware-attested multidimensional reserve adequacy metric produced by the Liquidity Integrity Engine using the reserve adequacy function h(alpha, beta, gamma) that quantifies an institution's liquidity sufficiency across applicable regulatory dimensions including LCR buffer adequacy, capital reserve ratio compliance, and net stable funding adequacy. The LIV constitutes the primary input to the Liquidity Containment Gate's threshold evaluation. Because the LIV is computed entirely within the TEE from hardware-attested inputs, its integrity is guaranteed by the TEE attestation report rather than by administrative assertion.

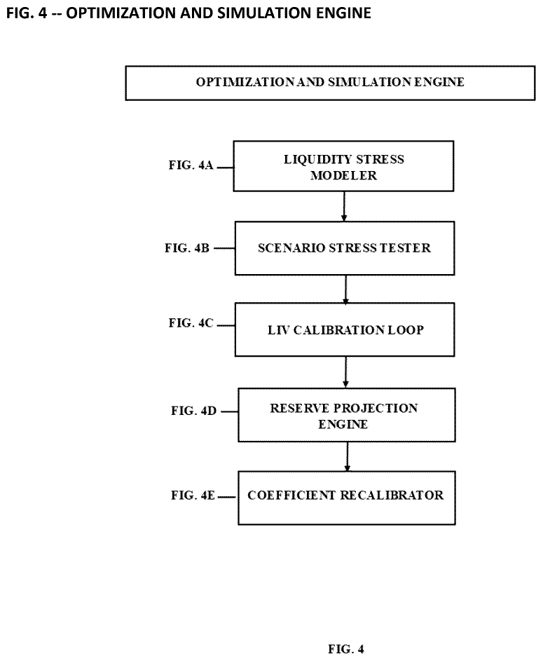

Liquidity Stress Modeler: A TEE-resident liquidity scenario analysis and reserve projection component (also referred to herein as the Optimization and Simulation Engine, as labeled in FIG. 4) that executes liquidity stress tests, reserve adequacy projections, and scenario analyses entirely within the hardware isolation boundary of the TEE. The Liquidity Stress Modeler uses hardware-attested Liquidity Integrity Vector values, Capital Reserve Monitor outputs, and current market parameters to model institutional liquidity behavior under adverse conditions—including sudden withdrawal events, counterparty default scenarios, and market liquidity disruptions—generating recalibration recommendations for the LIV Calibration Loop. All scenario outputs are cryptographically bound to the TEE attestation report of the hardware environment that produced them. This component executes within a TEE for protected, tamper-resistant liquidity scenario modeling.

Optimization and Simulation Engine: An alternate designation for the Liquidity Stress Modeler, as labeled in FIG. 4. See Liquidity Stress Modeler definition. Both designations refer to the same TEE-resident liquidity scenario modeling and stress-testing component.

Provenance Ledger: A permanent, append-only record of every Liquidity Integrity Vector computation, Capital Reserve Monitor validation, Liquidity Containment Gate authorization or denial, ZKP proof generation, settlement authorization, and Rollback Controller reversion processed by the system. It is structured as a cryptographic hash chain in which each new entry is mathematically linked to the entry before it, so that any attempt to alter, delete, or reorder a past entry propagates as a detectable inconsistency through all subsequent entries. Each ledger entry is cryptographically bound to a TEE attestation report that certifies the hardware environment and software configuration of the TEE at the time the associated computation was performed. This ledger provides the non-repudiable audit trail for regulatory examination, counterparty verification, and dispute resolution.

Settlement Attestation Binder: A TEE-resident component that cryptographically binds every settlement authorization to the TEE attestation report of the specific TEE Execution Instance in which the Liquidity Integrity Vector computation, Capital Reserve Monitor validation, and Liquidity Containment Gate evaluation were performed. The binding creates a non-repudiable linkage between the settlement outcome and the hardware execution environment that authorized it, enabling any party holding the verification key to confirm that the settled transaction was authorized by a validated, hardware-isolated computation and not by a software-level override or administrative action outside the TEE. This component executes within a TEE for tamper-resistant, attestation-anchored settlement finality.

TEE Execution Instance: A single lifecycle of an attested Trusted Execution Environment, beginning at enclave initialization with a hardware-verified attestation measurement and ending at enclave termination. All computations required to process a single settlement authorization event—including Liquidity Integrity Vector computation, Capital Reserve Monitor validation, Liquidity Containment Gate evaluation, ZKP proof generation, and Provenance Ledger recording—are performed within a single TEE Execution Instance to guarantee that all operations are governed by the same attested hardware environment and that the resulting provenance record is cryptographically bound to that instance.

ZKP Verification Engine: A TEE-resident cryptographic component that generates and verifies zk-SNARK proofs (Zero-Knowledge Succinct Non-Interactive Arguments of Knowledge) using Groth16 arithmetic circuit structures. The ZKP Verification Engine allows the system to prove to an External Counterparty or regulatory authority that a Liquidity Integrity Vector was computed, that the LIV satisfied the applicable reserve adequacy thresholds, and that the computation was performed in a hardware-isolated environment—without revealing the institution's proprietary balance sheet data, reserve position details, or regulatory coefficient parameters. Proofs generated by this engine are approximately 192 bytes in size (under 1 KB) and verifiable in under 10 milliseconds on standard server-grade hardware (e.g., a modern x86-64 processor at 3 GHz or equivalent) due to the constant-size verification complexity property of Groth16 proofs independent of circuit depth. This engine executes within a TEE for secure, privacy-preserving proof generation and verification.

### How the System Works—Technology Overview

The system operates as a continuous real-time enforcement pipeline that intercepts every settlement authorization request before it is committed to the external financial infrastructure. Balance sheet liquidity data, real-time exposure metrics, and regulatory capital coefficients enter through a hardware-secured Input Ingestion Gate, pass through the Liquidity Integrity Engine, Capital Reserve Monitor, Liquidity Containment Gate, and ZKP Verification Engine—all executing inside tamper-proof TEE hardware within a single TEE Execution Instance—and exit either as a hardware-authorized settlement event with a cryptographic commitment seal and ZKP proof, or as a blocked settlement event with a Rollback Controller reversion record. At every stage, the Provenance Ledger writes a permanent, tamper-evident record cryptographically bound to the TEE attestation report of the current TEE Execution Instance. The Liquidity Containment Gate enforces a mandatory hardware-validated execution barrier such that no settlement authorization may be released to an External Counterparty unless Liquidity Integrity Vector computation, Capital Reserve Monitor validation, ZKP proof generation, and Provenance Ledger recording have all completed successfully within the same TEE Execution Instance prior to enclave termination.

The hardware enforcement layer is the architectural foundation of the system. Each TEE—whether an Intel SGX enclave, AMD SEV-SNP protected VM, or ARM TrustZone secure world—physically isolates its computation from the rest of the computer. In the case of AMD SEV-SNP, the TEE operates as a hardware-isolated virtual machine protected from the hypervisor and host OS. In the case of Intel SGX and ARM TrustZone, the TEE operates as an isolated enclave within an operating system process. In all implementations, the Capital Reserve Monitor draws its monitoring signals from TEE-resident hardware mechanisms that are physically inaccessible to software outside the TEE, including the host operating system and any virtualization layer. This means that a compromised software stack—including a rogue administrator, malicious hypervisor, or adversarial code update—cannot falsify the inputs to the Liquidity Integrity Engine, suppress a reserve shortfall alert that the hardware has already generated, or authorize a settlement that the Liquidity Containment Gate has blocked.

### Step-by-Step Operation

Step 1—Input Ingestion: Balance sheet liquidity data, real-time exposure metrics, and regulatory capital coefficients arrive at the Input Ingestion Gate, which executes inside a TEE. The gate normalizes the data into a standardized schema, applies hardware-level privacy filters that prevent any unencrypted proprietary financial data from propagating outside the TEE boundary, and cryptographically transforms the inputs into hardware-protected memory pages within the TEE. The gate enforces strict schema validation, rejecting malformed or incomplete data objects before they enter the reserve validation pipeline. No input data exits the gate without being cryptographically transformed within the TEE and validated against the input schema.
Step 2—Liquidity Integrity Computation: The Liquidity Integrity Engine computes the Liquidity Integrity Vector inside the TEE using the reserve adequacy function h(alpha, beta, gamma), incorporating the institution's hardware-attested liquid asset buffers (alpha), real-time exposure metrics from the current transaction pipeline state (beta), and regulatory capital multipliers retrieved from the TEE-sealed policy store (gamma). The function h produces a multidimensional LIV that encodes the institution's reserve adequacy across all applicable regulatory dimensions at the time of computation. The resulting LIV is digitally signed and written as a pending entry to the Provenance Ledger.
Step 3—Hardware-Anchored Reserve Monitoring: The Capital Reserve Monitor validates the integrity and accuracy of the LIV computation by reading hardware-derived integrity signals from TEE-resident hardware mechanisms—specifically, enclave-sealed monitoring registers, memory encryption engine integrity states, and attestation-based recalibration triggers—confirming that input data quality has not drifted beyond the configured tolerance threshold since the last hardware-attested calibration cycle. If input quality drift exceeds the configured threshold, the Capital Reserve Monitor triggers a hardware-level liquidity suspension alert and suspends Liquidity Containment Gate evaluation pending hardware-attested recalibration and generation of a new TEE attestation report.
Step 4—Containment Gate Evaluation: The Liquidity Containment Gate evaluates all four authorization conditions—LIV satisfies applicable LCR and capital reserve thresholds, reserve ratios within authorized range, Capital Reserve Monitor integrity confirmation, and ZKP proof availability—against parameters retrieved from the TEE-sealed policy store within the same TEE Execution Instance. If all conditions are satisfied, the gate issues a hardware-authorized settlement signal. If any condition fails, the Liquidity Containment Gate blocks settlement finality, triggers a hardware-level liquidity alert, and routes the event to the Rollback Controller, which records the denial with full TEE attestation binding in the Provenance Ledger and reverts all pending pipeline state to the pre-ingestion checkpoint.
Step 5—ZKP Proof Generation and Liquidity Stress Modeling and Scenario Analysis: The ZKP Verification Engine and Liquidity Stress Modeler together perform ZKP proof generation and liquidity stress modeling and scenario analysis on the authorized settlement data. The ZKP Verification Engine generates a Groth16 arithmetic-circuit proof inside the TEE encoding the fact that the LIV satisfied all applicable reserve adequacy thresholds, producing a proof of approximately 192 bytes that any External Counterparty or regulatory authority can verify in under 10 milliseconds without accessing the institution's proprietary balance sheet data. Simultaneously, the Liquidity Stress Modeler models the portfolio-level liquidity impact of the settlement under stress scenarios to generate reserve projection recommendations for future LIV computation cycles.
Step 6—Provenance Recording: The Provenance Ledger records the complete reserve validation and settlement authorization event as a new append-only hash chain entry, binding the LIV value, Capital Reserve Monitor status, Liquidity Containment Gate decision, ZKP proof reference, and Liquidity Stress Modeler outputs to the TEE attestation report of the current TEE Execution Instance. Each entry is chained to the prior entry using a cryptographic hash, ensuring that any modification to any historical record propagates as a detectable hash chain inconsistency through all subsequent entries.
Step 7—Settlement Attestation and Final Seal: The Settlement Attestation Binder cryptographically binds the settlement authorization to the TEE attestation report of the TEE Execution Instance that authorized it, creating a non-repudiable linkage between the settlement outcome and the specific hardware environment that verified the reserve conditions. The Final Commit Seal applies an irreversible cryptographic closure to the completed transaction, anchoring the terminal hash into the append-only Provenance Ledger chain. The sealed settlement record is released to the External Counterparty's settlement system via the Settlement Authorization Gate, which enforces the requirement that all pipeline stages have completed within the same TEE Execution Instance prior to enclave termination before any settlement authorization exits the TEE.

### Zero-Knowledge Proof Implementation

The ZKP Verification Engine uses zk-SNARKs (Zero-Knowledge Succinct Non-Interactive Arguments of Knowledge)—a cryptographic proof type optimally suited to financial compliance applications because the proofs are small, fast to verify, and require no back-and-forth communication between the prover and verifier. Non-interactive means the system can generate the proof and transmit it to a regulatory authority or External Counterparty in a single step, with no follow-up exchange required. This is essential for real-time settlement environments where latency is a primary operational constraint. Arithmetic circuits encode the reserve adequacy constraints—LCR thresholds, capital reserve ratios, and Liquidity Integrity Vector threshold conditions—that must be satisfied for a valid proof, allowing the verifier to confirm that all conditions were met without accessing the underlying balance sheet data.

The system implements zk-SNARKs using a trusted setup ceremony performed inside a TEE that generates a proving key and a verification key. The proving key is used by the institution's settlement system to generate per-settlement reserve sufficiency proofs; the verification key is distributed to External Counterparties, regulatory verification systems, and clearing houses to verify them. Both keys are generated inside the isolated TEE so that neither the institution's administrators nor any external party can tamper with the setup parameters. Keys are periodically rotated upon hardware attestation events or calendar triggers, and prior keys are invalidated using enclave-sealed revocation lists, ensuring long-term cryptographic security even in the event of key compromise.

To generate a proof for a specific settlement authorization event, the system computes a mathematical value pi using the Liquidity Integrity Vector, Capital Reserve Monitor outputs, and applicable threshold conditions as private inputs along with the proving key. The computation occurs entirely inside the TEE. The resulting proof pi is transmitted to the External Counterparty along with public inputs—for example, the LCR threshold satisfied and the applicable capital reserve ratio range—without revealing the institution's proprietary balance sheet data or reserve position details. The counterparty's verification system checks whether pi is a valid proof for those public inputs using the verification key, returning a true or false result. Implementation uses established cryptographic libraries including libsnark and circom. Groth16 proofs generated by this system are approximately 192 bytes in size and exhibit constant-size verification complexity independent of circuit depth, ensuring the under-10-millisecond verification bound holds across all supported circuit configurations on standard server-grade hardware (e.g., a modern x 86-64 processor at 3 GHz or equivalent).

### Detailed Description of the Drawings

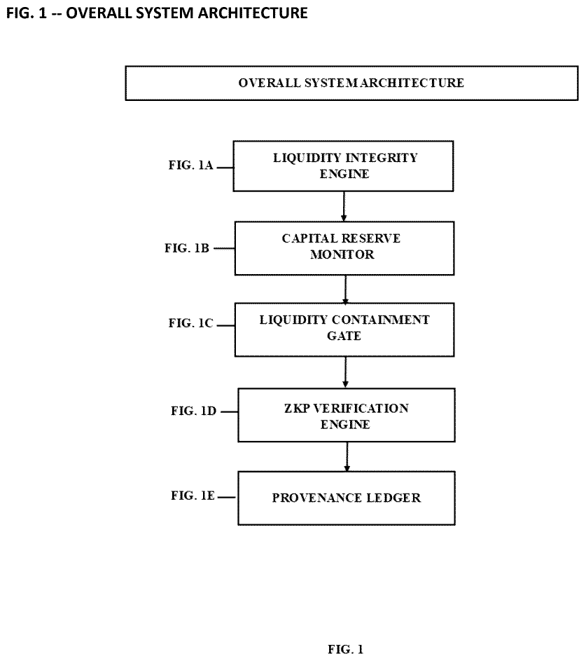

FIG. 1A—Liquidity Integrity Engine: Shows the core TEE-resident AI computation module that generates the Liquidity Integrity Vector from hardware-attested balance sheet inputs using the reserve adequacy function h(alpha, beta, gamma). The engine receives normalized financial data from the Input Ingestion Gate and processes it against a computation model sealed inside the TEE at initialization, so the model configuration at computation time is cryptographically bound to the TEE attestation report and cannot be silently modified between computation events. The resulting LIV is digitally signed and drives all downstream Liquidity Containment Gate, ZKP Verification Engine, and Settlement Attestation Binder operations.

FIG. 1B—Capital Reserve Monitor: Shows the hardware-anchored monitoring component that reads integrity signals from TEE-resident hardware mechanisms to validate that the Liquidity Integrity Engine's inputs have not drifted beyond the configured tolerance threshold. The monitor's integrity state is stored in enclave-sealed monitoring registers physically inaccessible to software outside the TEE, ensuring that reserve monitoring signals cannot be suppressed or falsified at the software level. When drift is detected, the monitor triggers a hardware-level suspension alert and records the event in the Provenance Ledger with a TEE attestation report before suspending the pipeline.

FIG. 1C—Liquidity Containment Gate: Shows the non-bypassable TEE-resident execution barrier that prevents settlement finality unless all four authorization conditions are satisfied within the same TEE Execution Instance. The gate applies the four-condition evaluation sequence—LIV threshold satisfaction, reserve ratio range compliance, Capital Reserve Monitor integrity confirmation, and ZKP proof availability—blocking the pipeline at the first unsatisfied condition and routing failed authorizations to the Rollback Controller with a full attestation-bound record of the failed condition.

FIG. 1D—ZKP Verification Engine: Shows the TEE-resident cryptographic component that generates Groth16 arithmetic-circuit proofs for External Counterparty and regulatory verification. The engine encodes reserve adequacy constraints—LCR thresholds, capital reserve ratio ranges, and Liquidity Integrity Vector threshold conditions—into arithmetic circuit structures, generating proofs of approximately 192 bytes that are verifiable in under 10 milliseconds. No proprietary balance sheet data or reserve position details exit the TEE through the proof generation process.

FIG. 1E—Provenance Ledger: Shows the append-only cryptographic hash chain that permanently records every system action. Each entry is chained to its predecessor using a cryptographic hash, making any alteration of a past entry immediately detectable as a hash chain inconsistency through all subsequent entries. Each entry is cryptographically bound to a TEE attestation report, enabling independent verification of both the recorded reserve event and the hardware environment in which it was computed. This ledger is the primary compliance artifact for regulatory auditors, External Counterparties, and clearing systems.

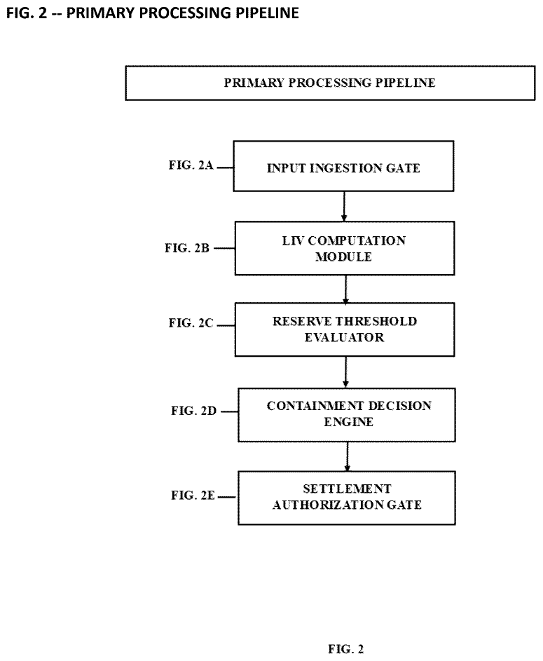

FIG. 2A—Input Ingestion Gate: Shows the TEE-resident entry point where balance sheet liquidity data, exposure metrics, and regulatory capital coefficients arrive and are normalized, privacy-filtered, and cryptographically transformed into hardware-protected memory pages before entering the reserve validation pipeline. The gate enforces strict schema validation, rejects malformed data objects, and ensures all accepted data is in a TEE-compatible secure format before any downstream component processes it.

FIG. 2B—LIV Computation Module: Shows the execution environment within the TEE where the Liquidity Integrity Engine applies the reserve adequacy function h(alpha, beta, gamma) to produce the Liquidity Integrity Vector. The module receives validated inputs from the Input Ingestion Gate, retrieves regulatory capital multipliers (gamma) from the TEE-sealed policy store, incorporates Capital Reserve Monitor status into the computation, and produces a signed LIV cryptographically bound to the current TEE attestation.

FIG. 2C—Reserve Threshold Evaluator: Shows the pre-gate comparison component that quantifies the relationship between the current Liquidity Integrity Vector and the applicable policy thresholds retrieved from the TEE-sealed policy store, producing a threshold satisfaction signal for the Containment Decision Engine. The evaluator executes inside the TEE to ensure threshold comparisons cannot be manipulated and its outputs are immediately recorded in the Provenance Ledger.

FIG. 2D—Containment Decision Engine: Shows the logic layer within the Liquidity Containment Gate that evaluates the four authorization conditions in sequence and routes the authorization outcome—approved or denied—to the appropriate downstream component. Approvals are routed to the ZKP Verification Engine and Settlement Authorization Gate; denials are routed to the Rollback Controller with a complete record of the failed condition and the specific LIV value at time of denial.

FIG. 2E—Settlement Authorization Gate: Shows the final checkpoint that releases settlement authorization to the External Counterparty's settlement system. The gate verifies that all four Liquidity Containment Gate conditions have been satisfied within the same TEE Execution Instance, that the ZKP proof has been generated, and that the Provenance Ledger entry for the event has been finalized. If any stage is incomplete or has failed, the Settlement Authorization Gate blocks release and triggers the Rollback Controller.

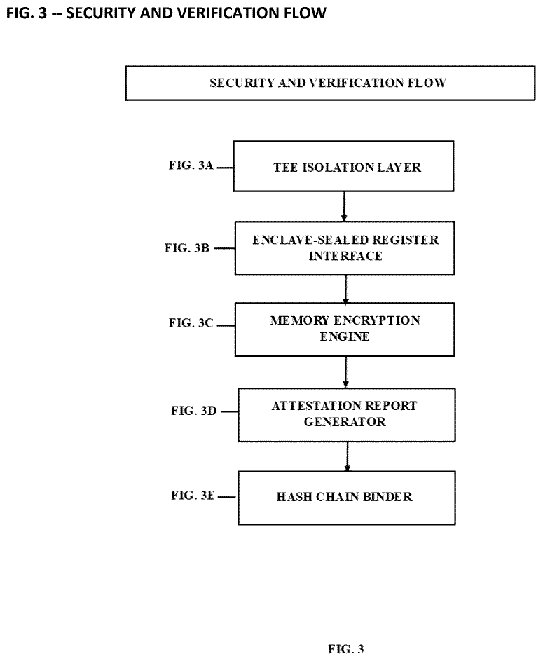

FIG. 3A—TEE Isolation Layer: Shows the hardware isolation boundary that separates all reserve computation, LIV generation, and settlement authorization from the external software environment. The isolation layer encompasses all pipeline components from the Input Ingestion Gate through the Final Commit Seal. Within this boundary, all computation is protected by the TEE's memory encryption engine, access control registers, and processor privilege enforcement, making it physically impossible for software outside the TEE to observe or modify computation state at any pipeline stage.

FIG. 3B—Enclave-Sealed Register Interface: Shows the interface through which the Capital Reserve Monitor reads hardware-derived integrity signals from the TEE's enclave-sealed monitoring registers. These registers are physically isolated within the processor and inaccessible to software executing outside the TEE. The interface provides the hardware-derived integrity state indicators that constitute the monitoring inputs to the Capital Reserve Monitor's drift detection function and drive the suspension alert logic when input data quality drift is detected.

FIG. 3C—Memory Encryption Engine: Shows the hardware component that encrypts all data stored in the TEE's memory pages, ensuring that sensitive balance sheet data, reserve computation state, and Liquidity Integrity Vector values cannot be extracted through physical memory attacks, cold-boot attacks, or hypervisor-level memory inspection. The memory encryption engine provides one of the primary hardware-anchored integrity guarantees on which the Capital Reserve Monitor's integrity state monitoring relies.

FIG. 3D—Attestation Report Generator: Shows the component that generates and embeds TEE attestation reports into Provenance Ledger entries, ZKP proof packages, and Final Commit Seals. The attestation report is a cryptographically signed statement produced by the TEE hardware—signed by the processor manufacturer's root key in the case of Intel SGX or AMD SEV-SNP—that certifies the identity, configuration, and integrity of the software executing inside the TEE at the time of attestation. This report enables External Counterparties, regulators, and clearing houses to verify not just the reserve compliance output, but that it was computed in a genuine, unmodified hardware-isolated environment.

FIG. 3E—Hash Chain Binder: Shows the cryptographic linking mechanism that chains each new Provenance Ledger entry to all preceding entries. Each new entry is hashed together with the hash of the prior entry and the TEE attestation measurement of the current TEE Execution Instance, creating a chain in which any modification to any historical entry propagates as a detectable inconsistency through all subsequent entries, providing the tamper-evident foundation for the system's non-repudiation guarantee.

FIG. 4A—Liquidity Stress Modeler: Shows the TEE-resident liquidity scenario analysis and reserve projection component (also referred to as the Optimization and Simulation Engine) that executes stress tests and scenario analyses inside the hardware isolation boundary. The modeler uses hardware-attested Liquidity Integrity Vector values and Capital Reserve Monitor outputs as inputs, ensuring that stress simulation results are based on verified, hardware-anchored reserve assessments. Simulation outputs drive the LIV Calibration Loop's recalibration recommendations.

FIG. 4B—Scenario Stress Tester: Shows the adversarial scenario execution environment within the Liquidity Stress Modeler where reserve positions are tested against extreme conditions—including sudden large withdrawal events, counterparty default cascades, market liquidity crises, and intraday settlement gridlock scenarios—to validate that the system's LIV thresholds and Liquidity Containment Gate policy parameters remain accurate under stress. Stress test results are recorded in the Provenance Ledger with full TEE attestation binding.

FIG. 4C—LIV Calibration Loop: Shows the feedback mechanism through which Scenario Stress Tester outputs, settlement outcomes, and Capital Reserve Monitor alerts update the Liquidity Integrity Engine's model parameters. All calibration updates execute inside the TEE to ensure that updated model configurations are hardware-attested, and the updated configuration is cryptographically bound to a new TEE attestation report before any new Liquidity Integrity Vector computation events are processed using the updated parameters.

FIG. 4D—Reserve Projection Engine: Shows the forward-looking reserve modeling component that projects the institution's expected liquidity position across configurable time horizons—intraday, overnight, one-week, and one-month—under the current settlement pipeline's pending obligations, enabling the Liquidity Containment Gate to apply forward-looking LIV thresholds for time-horizon-specific settlement authorization decisions.

FIG. 4E—Coefficient Recalibrator: Shows the component that translates Scenario Stress Tester outputs and LIV Calibration Loop results into recommended updates to the Liquidity Integrity Engine's regulatory capital multipliers (gamma) and LCR threshold parameters. Proposed coefficient updates are recorded in the Provenance Ledger as pending updates, and the Liquidity Containment Gate enforces a re-attestation requirement—requiring generation of a new TEE attestation report—before adjusted parameters are applied to any new settlement authorization event.

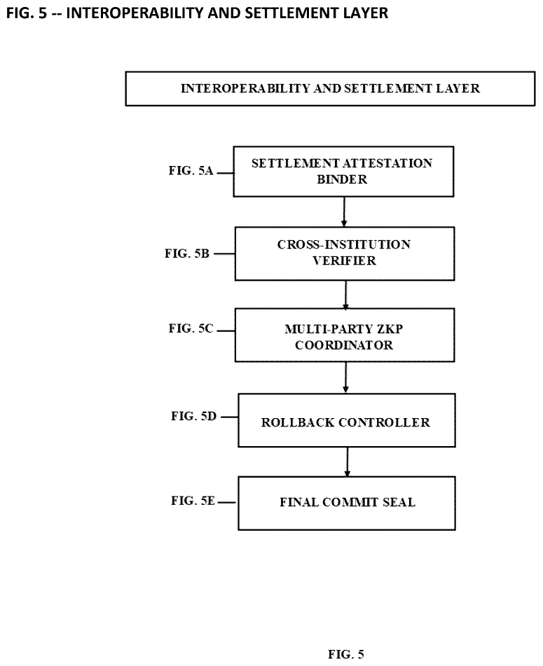

FIG. 5A—Settlement Attestation Binder: Shows the TEE-resident component that cryptographically binds every settlement authorization to the TEE attestation report of the specific TEE Execution Instance that authorized it. The binder creates a non-repudiable linkage between the settlement outcome and the hardware execution environment that verified the reserve conditions, enabling any party holding the verification key to confirm that the settled transaction was authorized by a validated, hardware-isolated computation and not by software-level intervention.

FIG. 5B—Cross-Institution Verifier: Shows the multi-institution settlement verification component that routes TEE-attested settlement authorizations and ZKP proofs to applicable clearing houses, central counterparties, and regulatory verification systems across multiple participating institutions. The Cross-Institution Verifier maintains a routing manifest in the Provenance Ledger for end-to-end audit traceability, with each routing event recorded and cryptographically bound to the originating TEE attestation report.

FIG. 5C—Multi-Party ZKP Coordinator: Shows the component that coordinates ZKP proof generation and verification across multiple External Counterparties participating in a single settlement or multilateral netting event. The Multi-Party ZKP Coordinator generates member-isolated Groth16 proofs for each participant inside the TEE, preventing any member from accessing another's proprietary reserve position while enabling all members to independently verify reserve sufficiency using the shared verification key.

FIG. 5D—Rollback Controller: Shows the state reversion mechanism triggered when the Liquidity Containment Gate blocks settlement authorization, when the Capital Reserve Monitor triggers a hardware-level suspension alert, or when a settlement event fails External Counterparty verification. The Rollback Controller reverts all pending pipeline state to the pre-ingestion checkpoint, records the reversion event in the Provenance Ledger with full TEE attestation binding, and initiates a re-attestation cycle before new settlement processing resumes.

FIG. 5E—Final Commit Seal: Shows the application of the terminal cryptographic seal to a fully authorized and settled transaction. Once applied, the seal makes any further modification to the record computationally impossible by anchoring the final hash into the append-only Provenance Ledger chain, wherein the final hash is cryptographically bound to the TEE attestation report verifying the hardware environment in which the Liquidity Integrity Vector computation, Capital Reserve Monitor validation, Liquidity Containment Gate authorization, and Settlement Attestation Binding were performed.

### Examples of Enablement

### Example 1—Intraday Settlement Authorization Under LCR Constraint (Intel SGX)

A global systemically important bank (G-SIB) deploys the Liquidity Containment and Capital Reserve Enforcement Engine to govern intraday settlement authorization across its wholesale payment system. During a high-volume settlement session, the bank's settlement system submits a large-value interbank payment authorization request. The Input Ingestion Gate, executing inside an Intel SGX enclave, receives and normalizes the institution's balance sheet liquidity data. The Liquidity Integrity Engine computes h(0.78, 0.31, 1.15)=0.84—a Liquidity Integrity Vector of 0.84 on the system's 0-1.0 normalized scale—against the applicable LCR threshold of 0.75 stored in the TEE-sealed policy store. The Capital Reserve Monitor reads the SGX enclave-sealed monitoring registers and confirms input data integrity with a drift metric of 2.1%, within the 4% configured tolerance threshold. The Liquidity Containment Gate evaluates all four authorization conditions within the same TEE Execution Instance and authorizes settlement. The ZKP Verification Engine generates a Groth16 proof inside the SGX enclave encoding satisfaction of the LCR threshold, producing a proof of 192 bytes transmitted to the receiving bank's clearing system and verified in 3 milliseconds. The Settlement Attestation Binder binds the settlement confirmation to the SGX attestation report and the Final Commit Seal is applied. The entire authorization-to-settlement sequence completes in 18 milliseconds. The bank's intraday settlement rejection rate for reserve-insufficient transactions decreases by 31% over the prior six-month period, while clearing system audit processing time decreases by 76% due to replacement of record-level manual review with constant-size cryptographic verification.

### Example 2—Capital Reserve Shortfall Detection and Rollback (AMD SEV-SNP)

A regional bank deploys the system to enforce Basel III capital reserve adequacy conditions on its securities settlement pipeline. During a period of elevated trading volume, the bank's reserve position deteriorates following a series of large outbound settlement payments executed in rapid succession. The Capital Reserve Monitor, executing inside an AMD SEV-SNP protected VM, reads through its enclave-sealed monitoring registers and memory encryption engine integrity states that the Liquidity Integrity Engine's input beta—real-time exposure metrics—has spiked, driving an updated Liquidity Integrity Vector of h(0.61, 0.58, 1.15)=0.51, which falls below the applicable LCR threshold of 0.75 stored in the TEE-sealed policy store. The Liquidity Containment Gate evaluates the authorization conditions and blocks settlement finality on three pending payment authorizations within the same TEE Execution Instance. The Rollback Controller reverts all three pending pipeline instances to their pre-ingestion checkpoints. The Capital Reserve Monitor simultaneously detects that the input quality drift for the beta exposure metric has reached 9.2%, exceeding the 7% configured suspension threshold, and triggers a hardware-level liquidity suspension alert. The Provenance Ledger records all three reversion events and the suspension alert with full AMD SEV-SNP attestation binding, providing the bank's risk management team and applicable regulatory authority with a complete, non-repudiable audit trail including the specific LIV value (0.51), the threshold not satisfied (0.75), the three payment identifiers blocked, the drift metric value (9.2%) at time of detection, and the TEE attestation measurement of the execution instance. The entire detection, blocking, and documented reversion sequence completes in under 280 milliseconds.

### Example 3—Multi-Institution Central Counterparty Netting Settlement (ARM TrustZone)

A central counterparty (CCP) deploys the system to govern multilateral netting settlement across twelve clearing members representing institutions in four regulatory jurisdictions. Each clearing member submits balance sheet reserve position data for the netting cycle. The Multi-Party ZKP Coordinator, executing inside an ARM TrustZone secure world TEE, generates member-isolated Groth16 proofs for each of the twelve clearing members, encoding each member's reserve sufficiency under its applicable jurisdiction-specific LCR threshold—without allowing any member to access another's proprietary reserve position or balance sheet data. The Liquidity Containment Gate evaluates all twelve member Liquidity Integrity Vectors against the CCP's multilateral netting policy thresholds within the same TEE Execution Instance. Ten members satisfy all conditions; two members fall below their applicable thresholds with LIV values of 0.68 and 0.71 respectively, against a 0.80 threshold. For the ten compliant members, the Settlement Attestation Binder applies attestation-bound settlement authorization; for the two non-compliant members, the Rollback Controller triggers reserve-deficiency blocks recorded in the Provenance Ledger with full TrustZone attestation binding. The Cross-Institution Verifier routes the ten authorization proofs to the applicable clearing houses across all four jurisdictions, each of which verifies its respective proof in under 6 milliseconds. The Liquidity Stress Modeler models the netting cycle's portfolio-level liquidity impact under a market stress scenario incorporating the two excluded members'deferred obligations, generating updated reserve projection recommendations for the next netting cycle. The Final Commit Seal anchors the terminal hash with a TrustZone attestation report confirming the hardware environment in which all twelve member evaluations were performed. The CCP achieves a 44% reduction in netting cycle completion time compared to the prior manual reserve verification process.

What is claimed is:

1. A hardware-secured liquidity containment and capital reserve enforcement system comprising a trusted execution environment (TEE) comprising an Intel SGX enclave, AMD SEV-SNP protected VM, or ARM TrustZone secure world materially altering the processor state by invoking secure enclave isolation, the TEE executing a Liquidity Integrity Engine configured to compute a Liquidity Integrity Vector using the reserve adequacy function h(alpha, beta, gamma), wherein alpha represents liquid asset buffers, beta represents real-time exposure metrics, and gamma represents regulatory capital multipliers retrieved from a TEE-sealed policy store; a Capital Reserve Monitor executing within the TEE anchored to TEE-resident hardware mechanisms comprising enclave-sealed monitoring registers, memory encryption engine integrity states, or attestation-based recalibration triggers, configured to validate reserve adequacy and to trigger a hardware-level suspension alert when input data drift exceeds a configurable tolerance threshold; a Liquidity Containment Gate executing within the TEE configured to prevent settlement authorization absent satisfaction of Liquidity Integrity Vector thresholds retrieved from a TEE-sealed policy store, wherein all Liquidity Integrity Vector computation, Capital Reserve Monitor validation, and gate evaluation operations complete within a single attested TEE execution instance prior to enclave termination; a Provenance Ledger comprising an append-only cryptographic hash chain wherein each ledger entry is cryptographically bound to a TEE attestation report corresponding to the hardware environment in which the associated computation was performed; and a ZKP Verification Engine executing within the TEE configured to generate Groth16 arithmetic-circuit proofs of approximately 192 bytes verifiable in under 10 milliseconds on standard server-grade hardware, enabling External Counterparty verification of reserve sufficiency without exposure of underlying proprietary balance sheet data.

2. A method of hardware-secured liquidity enforcement comprising ingesting balance sheet liquidity data, real-time exposure metrics, and regulatory capital coefficients into a trusted execution environment (TEE) comprising an Intel SGX enclave, AMD SEV-SNP protected VM, or ARM TrustZone secure world materially altering the processor state by invoking secure enclave isolation; computing a Liquidity Integrity Vector within the TEE using the reserve adequacy function h(alpha, beta, gamma), wherein alpha represents hardware-attested liquid asset buffers, beta represents real-time exposure metrics, and gamma represents regulatory capital multipliers retrieved from a TEE-sealed policy store; anchoring reserve monitoring to TEE-resident hardware mechanisms comprising enclave-sealed monitoring registers, memory encryption engine integrity states, or attestation-based recalibration triggers, suspending settlement authorization upon detecting input data drift exceeding a configurable tolerance threshold; evaluating all Liquidity Containment Gate authorization conditions against thresholds retrieved from the TEE-sealed policy store within the same TEE execution instance;
blocking settlement authorization when any authorization condition is unsatisfied and recording the blockage in an append-only Provenance Ledger cryptographically bound to a TEE attestation report; generating Groth16 arithmetic-circuit proofs of approximately 192 bytes verifiable in under 10 milliseconds upon threshold satisfaction for External Counterparty verification without exposure of proprietary balance sheet data; and releasing settlement authorization to an External Counterparty only after completion within the TEE of Liquidity Integrity Vector computation, Capital Reserve Monitor validation, Liquidity Containment Gate evaluation, ZKP proof generation, and Provenance Ledger recording within a single attested TEE execution instance prior to enclave termination.

3. A hardware-secured settlement authorization subsystem comprising a trusted execution environment (TEE) comprising an Intel SGX enclave, AMD SEV-SNP protected VM, or ARM TrustZone secure world materially altering the processor state by invoking secure enclave isolation; a Liquidity Containment Gate executing within the TEE configured to enforce deterministic reserve adequacy conditions as a non-bypassable pre-condition to settlement finality, evaluating Liquidity Integrity Vector threshold satisfaction, Capital Reserve Monitor integrity confirmation, and ZKP proof availability within a single attested TEE execution instance prior to enclave termination; a Settlement Attestation Binder executing within the TEE configured to cryptographically bind settlement authorizations to TEE attestation reports corresponding to the hardware environment in which the associated Liquidity Integrity Vector computation and Liquidity Containment Gate evaluation were performed, wherein each settlement authorization includes a reference to the specific TEE attestation report identifier of the TEE execution instance that authorized it; a Liquidity Stress Modeler (also referred to herein as the Optimization and Simulation Engine) executing within the TEE configured to execute liquidity stress tests and reserve adequacy projections using hardware-attested Liquidity Integrity Vector values and Capital Reserve Monitor outputs, with drift detection anchored to TEE-resident hardware mechanisms comprising enclave-sealed monitoring registers, memory encryption engine integrity states, or attestation-based recalibration triggers; and a Provenance Ledger comprising an append-only cryptographic hash chain wherein each ledger entry is cryptographically bound to a TEE attestation report, enabling independent verification of both the settlement authorization outcome and the hardware environment that authorized it.

4. The system of claim 1, wherein the ZKP Verification Engine encodes Liquidity Integrity Vector threshold conditions, LCR reserve adequacy constraints, and Capital Reserve Monitor authorization criteria into Groth16 arithmetic circuit structures using cryptographic libraries including libsnark and circom, with Groth16 constant-size verification complexity independent of circuit depth ensuring the under-10-millisecond verification bound holds across all supported reserve adequacy circuit configurations on standard server-grade hardware.

5. The system of claim 1, wherein the TEE-resident hardware mechanisms include memory encryption engine integrity states that encrypt all data stored in TEE memory pages, preventing extraction of balance sheet data, reserve computation state, or Liquidity Integrity Vector values through physical memory attacks, cold-boot attacks, or hypervisor-level memory inspection.

6. The system of claim 1, wherein the Capital Reserve Monitor triggers a hardware-level liquidity suspension alert and suspends Liquidity Containment Gate authorization when input data drift detected via TEE-resident hardware mechanisms exceeds the configurable tolerance threshold, requiring hardware-attested recalibration and generation of a new TEE attestation report before settlement processing resumes.

7. The system of claim 1, wherein the regulatory capital multipliers gamma incorporate domain-specific regulatory coefficients applicable to Basel III Liquidity Coverage Ratio requirements, Net Stable Funding Ratio standards, and applicable domestic financial reserve regulation, with all regulatory coefficients stored in a TEE-sealed policy store that cannot be modified without generating a new hardware attestation event.

8. The system of claim 1, wherein each Provenance Ledger entry comprises a cryptographic hash of the prior ledger entry chained with the TEE attestation measurement of the current TEE execution instance, such that modification of any historical entry propagates as a detectable hash chain inconsistency through all subsequent entries.

9. The system of claim 1, wherein the ZKP Verification Engine implements Groth16 proofs using trusted setup ceremonies performed inside a TEE, with proving key rotation tied to hardware attestation events and prior proving keys invalidated using enclave-sealed revocation lists.

10. The system of claim 1, further comprising a Liquidity Stress Modeler executing within the TEE configured to execute liquidity stress tests and reserve adequacy projections under adverse scenarios using hardware-attested Liquidity Integrity Vector values, generating recalibration recommendations cryptographically bound to the TEE attestation report of the simulation execution instance.

11. The system of claim 1, wherein the Liquidity Containment Gate enforces a mandatory execution barrier requiring that Liquidity Integrity Vector computation, Capital Reserve Monitor validation, and ZKP proof generation complete within a single attested TEE execution instance prior to enclave termination before any settlement authorization is released to an External Counterparty, with any incomplete or failed pipeline stage triggering the Rollback Controller.

12. The method of claim 2, wherein detecting input data drift triggers hardware-level recalibration using enclave-sealed monitoring registers, suspending settlement authorization until a new TEE attestation report is generated confirming recalibrated reserve model integrity and a drift metric within the configured tolerance threshold.

13. The method of claim 2, wherein the Groth16 arithmetic-circuit proofs exhibit constant-size verification complexity independent of circuit depth, ensuring the under-10-millisecond verification bound holds regardless of the complexity of the reserve adequacy circuit configuration on standard server-grade hardware.

14. The method of claim 2, further comprising binding each settlement authorization event to a specific TEE attestation report identifier corresponding to the TEE execution instance in which the Liquidity Integrity Vector computation and Liquidity Containment Gate evaluation were performed, enabling independent parties to verify that a specific hardware execution instance authorized a specific settlement event.

15. The system of claim 3, further comprising a Cross-Institution Verifier configured to route TEE-attested settlement authorizations and ZKP proofs to applicable clearing houses, central counterparties, and regulatory verification systems across multiple participating institutions, maintaining a routing manifest in the Provenance Ledger with cryptographic binding to the originating TEE attestation report for each routing event.

16. The system of claim 3, further comprising a Multi-Party ZKP Coordinator executing within the TEE configured to generate member-isolated Groth16 proofs for multiple External Counterparties participating in a multilateral netting or settlement event, preventing any member from accessing another's proprietary reserve position while enabling independent verification of reserve sufficiency by all members.

17. The system of claim 3, further comprising a Rollback Controller executing within the TEE configured to revert pending pipeline state to a pre-ingestion checkpoint upon Liquidity Containment Gate denial or Capital Reserve Monitor suspension alert, recording the reversion event in the Provenance Ledger with full TEE attestation binding and initiating a re-attestation cycle before new settlement processing resumes.

18. The system of claim 3, further comprising a LIV Calibration Loop executing within the TEE configured to incorporate Scenario Stress Tester outputs, settlement outcomes, and Capital Reserve Monitor alerts into Liquidity Integrity Engine model parameter updates, with all calibration updates cryptographically bound to a new TEE attestation report before application to subsequent Liquidity Integrity Vector computation events.

19. The system of claim 3, further comprising a Coefficient Recalibrator executing within the TEE configured to translate Liquidity Stress Modeler scenario outputs into recommended updates to the Liquidity Integrity Engine's regulatory capital multipliers gamma, with proposed coefficient updates requiring Liquidity Containment Gate re-attestation confirming generation of a new TEE attestation report before application to new settlement authorization events.

20. The system of claim 3, wherein the Provenance Ledger records settlement authorization events with cryptographic hash-chain binding to specific TEE attestation report identifiers corresponding to the TEE execution instances in which the associated Liquidity Integrity Vector computations, Capital Reserve Monitor validations, and Liquidity Containment Gate evaluations were performed, enabling independent verification of both the settlement authorization outcome and the identity of the hardware execution environment that authorized it.
